(19) United States
(12) Patent Application Publication
(10) Pub. No.: US 2003/0048899 A1
(43) Pub. Date: Mar. 13, 2003

(54) Method and apparatus for securing electronic information

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 10/099,094

(22) Filed: Mar. 18, 2002

(30) Foreign Application Priority Data
Sep. 10, 2001 (GB) 0121819.7

(51) Int. Cl. H04K 1/04

(52) U.S. Cl. 380/37

(57) ABSTRACT

This invention presents a method and apparatus for securing electronic information by encryption. The method presented can be used to encrypt and decrypt information at any encryption strength, in either stream or file format, and can be easily parallelised for efficient implementation in either hardware or software.

### BACKGROUND OF THE INVENTION

Information is often the most important asset a company or individual has. Much of this information is increasingly being represented, stored and transmitted electronically and the privacy of this electronic information is of paramount importance to its owner.

There are two main ways to secure electronic information these are with either stream or block ciphers. An example of a stream cipher is the RC4 encryption method where information bits are mixed with a random number generator's output to create an encrypted cipher-text. An example of a block cipher is the DES encryption method where 64 bits of information are taken at a time and mixed with each other and a key over 16 rounds of an algorithm. In both of these examples a key is used to initialise the encryption method and the method is simply applied again—with the same key in the same order—to decrypt a cipher-text and obtain back the original information.

This invention presents a hybrid method for encrypting information. The method uses a random number generator like a stream cipher but acts on a block of information at a time. The method has a number of great advantages over pervious methods including notably that any strength of encryption can be applied using the same method and that the method is relatively easy to implement and parallelise making it perfect for light equipment and implementing in dedicated hardware or microchips.

### BRIEF SUMMARY OF THE INVENTION

It is an object of the present invention to provide a method and apparatus for securing electronic information. The method as presented works with all forms of electronic information including files and data streams and secures the information using any required encryption strength.

It is a second object of the present invention to provide a method and apparatus for the recovery of the secured electronic information so that the original information can be decrypted and used.

These and other objects, advantages and features of the present invention are provided by a new method for information encryption comprising at least 4 logical steps:

1. A block of the information is taken with the required number of plain-text bits

2. A random number generator is used to select a bit at random in the block for transformation

3. The bit is transformed according to the cipher-function

4. Steps 2-3 are repeated for the required number of rounds until the block is encrypted. The process continues until all the blocks of information have been encrypted

In a method according to the invention, the plain-text information is grouped for encryption in blocks. These blocks can be of any length (any number of bits). Where there is not enough plain-text information available to fill a block, the plain-text may be padded to the required length.

In a second method according to the invention, a random number generator is used to select locations within the block for transformation. The random number generator may be of the form of a one-time-pad or initialised using a key so that the random sequence can be repeated and the data can be recovered.

In another method of the invention, the bits selected in stage 2 are transformed according to the cipher-function and replaced in the block. In its simplest form, the cipher-function merely NOTs the bits as they are selected. However, other transformations are envisaged including swapping two bits over and stateful transforms.

In a further method of the invention, the process of selecting and transforming bits is continued for a number of rounds (continued a number of times). The exact number of rounds is implementation specific but should be large enough so that a significant number of bits in the input block are effected to produce a sufficiently transformed cipher-text.

In a further method of the invention, the encrypted information is decrypted and recovered by the application of the invention in reverse. In the preferred embodiment presented here however, the transformations are symmetric and the plain-text can be recovered by the application of the invention to the ciphered-text in the same order as used to encrypt the plain-text and using the exact same cipher-function.

In an embodiment of the system according to the invention the blocks size is varied throughout the encryption process. In this embodiment, the length of each block has to be determined in a reproducible manner (so that the cipher-text can be decrypted again). This can be achieved by either taking a list of all the block sizes from a random number generator at initialisation (i.e. before any transformations) or by taking only the next block size form the random number generator before creating and transforming that block or another means.

In an embodiment of the system according to the invention the last block of the plain-text consists of a length indicator followed by the data and then a set of pad bytes. This copes with the situation where there is not enough data to fill the last block completely. Alternatively, where there is not enough data left in the input stream to fill the last block, the last block size can be limited to the amount of data available. This removes the need for padding, length flagging and data expansion.

In a further embodiment of the system according to the invention the entropy of the cipher-text is enhanced by applying a second cipher to the information before it is passed through the method of the present invention (a pre-cipher) and/ or to the cipher-text produced by the present invention (a post-cipher). An example is the application of a RC4 cipher to the plain-text blocks before they are transformed with the present invention.

In another embodiment of the system according to the invention data is twisted (cyclically rotated in a defined direction) by an amount to increase the decryption complexity. The data can either be twisted in each block independently or as a whole across the entire information source. The twist can be applied either before or after encryption and the amount of twist can be determined by values taken from the random number generator or by some other means (e.g. key characteristics). Additionally a random pad can be added to the data at its beginning or end. The pad length can again be randomised by obtaining it from the pseudo random number generator.

In yet another embodiment of the system according to the invention the encryption process is parallelised. This parallelism can be implemented in hardware or software. A possible method is to initialise several independent random number generators and to encrypt several blocks of the plain-text in parallel using the method of this invention. The random number generators may be initialised with the same or different keys (or portions of a combined key) to increase the effective key length of the method and so exceed any limitations imposed by the random number generators themselves.

Finally, the effective key length can be increased during normal operation by initialising several independent random number generators with different parts of a long key and using the combined output of these generators (perhaps one after another or in XOR combination). The encryption strength may be increased by applying the invention to the information a number of times perhaps with different block lengths and different keys. Additionally, blocks can be chained together for example by XORing the cipher-text from one block with the plain text of another block before applying the invention to the second block.

### DETAILED DESCRIPTION

A preferred embodiment of the invention will now be disclosed, without the intention of a limitation, in a computer system for the purpose of encrypting and decrypting files. In this illustration of the preferred embodiment, for simplicity the block size will be fixed at 1024 bits, there will be no twisting or padding and the process will not be parallelised.

We will consider first the encryption of a plain-text file before examining the decryption of the corresponding cipher-text file. It will be assumed that the file is constructed of bytes—this assumption is important for constructing the last block length indicator used here. For illustrative purposes only, a single RC4 algorithm will be used as the random number source. The RC4 generator is first initialised with a key supplied by the user for the file and pseudo random numbers can then be taken from the generator in groups of 8 bits (1 byte).

After the plain-text file is been opened, pointers are initialised to the start of the file and the encryption process begins following these steps:

1. 1024 bits (128 bytes) of information are read from the file into a bit buffer held in memory. Where there is not enough data left in the file to fill the whole 1024 bit buffer then the first byte (8-bits) of the buffer will store the length of data (in bytes) available in the buffer, and this will be followed by the actual data bits from the file (this is the last block in the cipher-file).

2. For simplicity, 2 bytes are then read from the random number generator. The first 10 bits of these 2 bytes are then used to specify the location of a bit in the 1024 bit buffer for transformation.

3. The value of the bit at the randomly selected location is then transformed according to the cipher-function. In this, the preferred embodiment of the invention, the cipher-function is to simply NOT the bit at the selected location. This transform has the effect of increasing the entropy in the block without the need for an additional pre- or post-cipher.

4. Steps 2-3 are repeated for the required number of rounds. The exact number of rounds depends on the encryption certainty required and is discussed in more detail below.

5. The transformed block is then saved in a cipher-text version of the file and the process is repeated for the next block of input data until a last block has been transformed. In this embodiment, if the file size is evenly divisible by 1024 bits then the last block will have no plain-text data in it and will have a first byte length flag of 0.

At the core of the encryption process is the application of the cipher-function to bits selected at random in the block. This transformation is applied a certain number of times (a number of rounds) so that the block's bits become encrypted/ mixed-up. The number of rounds effects the quality of the cipher and ideally we would want every bit in the block to have been transformed at least once so that no holes are left in the block. It can be shown that the average number of bits effected in a block by a number of rounds using the preferred embodiment is given by the following formula:

f(n, r)=n−n.(1−1/nˆ (Eq. 1)

Where:

n is the number of bits in the block

r is the number of rounds applied to the plain-text block

ˆ is the mathematical power sign

From this formula it is easy to show that the number of rounds required to ensure that 7 out of every 8 bits in the block are transformed is around 2150 rounds. The number of rounds increases to 4916 to ensure that an average of 99% of the bits are effected (127 out of every 128 bits effected).

Because of the symmetry in the cipher-function, the cipher-text file can be decrypted by applying the same transformation to the encrypted cipher-text file as was applied to the plain-text file (with the obvious exception of the last block padding).

First, the encrypted cipher-text file is opened and the read pointers initialised to the start of the file. The random number generators are initialised again with the same key used to encrypt the file and the decryption process proceeds as below:

1. 1024 bits of the encrypted file are read into a bit buffer.

2. As before, 2 bytes are read from the random number generator and masked to address a bit in the 1024 bit block.

3. The value of the bit is read from the randomly selected location in the buffer and transformed according to the same cipher-function used for encryption (i.e. a NOT).

4. Steps 2-3 are repeated for the same number of rounds as that used to encrypt the block.

5. If this is the last block in the file, the first byte is read from the buffer to indicate the number of data bytes in the block and then that number of bytes are saved to the decryption file. Otherwise the entire block is appended to a decryption file and stages 1-5 repeated.

In this embodiment, the cipher-function is simply to NOT the randomly selected bits in the block. Other cipher-functions are envisaged according to the invention, including:

a. Acting on a number of bits at a time, for example selecting two bits of the block at random and swapping their contents or applying a DES to sub-blocks selected at random in the block

b. Applying an XOR to a group of bits starting at the randomly selected address (or an 8-bit boundary thereof) and using either a fixed mask, one derived from a random stream, one derived from the data or another source

c. Stateful transformation functions, for example XORing the current randomly selected bit with a running total of all selected bits so far XORed together

It is recognised that alternative cipher-functions may not be symmetric in that reverse transformations have to be constructed to recover a plain-text from a cipher-text. Where this is the case, decryption can be achieved by selecting and storing a list of random numbers from the initialised random number generator and selecting and applying these numbers in reverse order to the block with a reverse cipher-function. It is recognised that this may require the number of rounds to be fixed or at least plain-text independent.

As a further example of an alternative cipher-function that could be used with the current embodiment, the 2 bytes selected from the random number generator in stage 2 of the process presented could perhaps be better utilised by applying a stateful group cipher. This cipher-function could use the first 10 bits of the 16 random bits selected to again identify locations in the bit buffer but use the last 6 bits to identify a length of bits from that point that will be selected as a group and XORed with the random location derived from the first 10 bits of the random number in the next round. In this cipher-function (as presented) the first round would do nothing and in every other round there would be a group XOR and a new group of bits identified for XORing with a position next time. The block could be cyclically wrapped where the selected group passes the end of the buffer.

In accordance with a method of the invention, the entropy of the buffer can be increased by applying a pre- or post-cipher. An example of this approach for the current embodiment is to XOR each byte in the initialised buffer with 128 bytes of random data from the random number generator. Alternatively, the last block's cipher-text could be XORed with the next block's plain-text before encryption—this is particularly easy to implement if the same buffer memory is used for each block and would constitute a ‘chaining’ method. In this second case, the buffer may be initialised at the start of the process with bytes taken from the random number generator.

In another embodiment according to the invention, any bits in the last buffer that are not filled with data are padded with a random stream of bits. This random stream could be generated using a second separate random number generator. In the embodiment as presented, the bit buffer can either be wiped after each block (setting the bits after the data in the last block to either 1 or 0) or not (leaving random bits in the last block). The second of these options is preferred and is potentially the easiest to implement.

As an enhancement to the embodiment presented, the number of rounds could be made variable. The exact number of rounds could be either determined from a (biased) initialised random number generator or by monitoring the number of bits that have been effected in the block and stopping the process when the required number of bits have been transformed (perhaps 7 bits in every byte).

It is easy to see how the invention would be parallelised using several random number generators. The generators could either be initialised with the same key and “fast-forwarded” so that the resulting cipher-text could be decrypted in a non-parallel manor or they could use different keys to increase the cipher-strength. To encrypt two blocks in parallel using the “fast-forwarding” approach in accordance with this embodiment and assuming 2150 rounds, two RC4 generators would first be initialised with the same key and then 2150 addresses (4300 bytes) would be read and dumped from the second random number generator. The two blocks would then be encrypted in parallel using their respective generators. Alternatively a single random number generator can be used and the random numbers stored in some kind of array so that the first cipher uses the random addresses 0 to 2150 and the second cipher uses the random addresses 2151 to 4300.

Along with the objects, advantages and features described, those skilled in the art will appreciate other objects, advantages and features of the present invention still within the scope of the claims as defined. For instance, it is easy to see how the preferred embodiment can be adapted to work with another block size or another random number generator. The embodiment can be adapted to work with streamed information sources in a similar way to block ciphers like the DES algorithm.

We claim:

1. A method for securing electronic information through encryption, characterised by:
a) Dealing with a block of the information at a time
b) Selecting bits at random from the block
c) Transforming the selected bits according to a cipher-function
d) Repeating steps b and c for a number of rounds.

2. A method in accordance with claim 1, for recovering the plain-text electronic information from the cipher-text, characterised by either:
a) The reapplication of the encryption process to the cipher-text using the same cipher-function
b) The application of the exact reverse encryption process including a reverse cipher-function and applying the transformation to the randomly selected addresses in reverse order
c) A combination of a and b.

3. A method according to claims 1 or 2 wherein said block size can be varied or fixed.

4. A method according to claim 3 wherein the block size is varied according to values derived from a random number generator.

5. A method according to any of the previous claims wherein the bits are selected using an pseudo random number generator (initialised with a key), a one-time pad or a similar repeatable function.

6. A method according to any of the previous claims wherein the cipher-function is equivalent to NOTing the selected bits.

7. A method according to any of the previous claims wherein the cipher-function acts on more than one bit at a time in the block by either:
a) Swapping the contents of selected bits
b) Applying a second cipher to the bits at the randomly selected locations in the block
c) XORing a group of bits at randomly selected locations in the block.

8. A method according to any of the previous claims wherein the cipher-function is stateful.

9. A method according to any of the previous claims wherein the process is repeated until the entire input information has been encrypted block by block.

10. A method according to claim 9 wherein the last plain-text block is characterised by either:
a) A length indicator at a known position in the block, the last available data elsewhere in the block and optional padding bytes
b) A variable block size.

11. A method according to any of the previous claims wherein the blocks are either transmitted through a network or communications medium after creation or stored for later use in a file, database or other storage mechanism.

12. A method according to any of the previous wherein the number or rounds is either:
a) Randomly determined
b) Calculated to ensure an average number of bits are effected in accordance with equation 1 of this work
c) Determined practically by watching the block bits to ensure the required number have been effected.

13. A method according to any of the previous claims wherein a twist or pad is applied to the individual blocks or a group of blocks.

14. A method according to any of the previous claims, wherein the block has additional ciphers applied.

15. A method according to any of the previous claims where past block results are reused for subsequent calculations, including:
a) Where the cipher-text of a pervious block is XORed with the starting plain-text in a next block before encryption
b) As a means to avoid the need for random padding in final blocks.

16. A method according to any of the previous claims wherein the process is parallelised through the use of:
a) Several random number generators independently initialised with different or the same keys
b) Several random number generators initialised with the same key and “fast-forwarded” to different positions
c) A single random number generator and a buffer to store a random sequence that can be accessed at different locations by the ciphers of different blocks.

17. A method according to any of the previous claims wherein several random number generators are used co-operatively.

18. A method or apparatus substantially as described herein.

19. Apparatus configured or adapted to perform any one of the methods of the previous claims.
